(19) United States
(12) Patent Application Publication
(10) Pub. No.: US 2011/0016506 A1
(43) Pub. Date: Jan. 20, 2011

(54) Set-Top Box

(76) Inventor: Yung-Yu Lu, Taoyuan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/503,240

(22) Filed: Jul. 15, 2009

(51) Int. Cl. H04N 7/16

(52) U.S. Cl. 725/151

(57) ABSTRACT

An integrated type set-top box includes a first receiver receiving a signal transmittable under high speed download packet access. A second receiver receives a signal transmitted from a digital image transmission platform and outputs a demodulated signal. A decoder is coupled to the second receiver. The decoder receives the demodulated signal from the second receiver and decodes the demodulated signal into a decoded signal. A microprocessor is coupled to the first receiver, the decoder, and a display port. The microprocessor receives the signal from the first receiver and the decoded signal from the decoder and selectively outputs the signal from the first receiver or the decoded signal from the decoder to the display port.

### BACKGROUND OF THE INVENTION

The present invention relates to a set-top box and, more particularly, to an integrated type set-top box capable of receiving digital video signals and transmitting the digital video signals to a display.

Conventional analog televisions receive analog signals and then output images and sound. However, the analog signals are liable to be interfered during transmission, such that the picture clarity and anti-noise performance are adversely affected. Digital televisions have become more and more popular for the ability of filtering noise from the digital signals. Currently, a set-top box is mounted on a television for receiving digital signals and transmitting the digital signals to the television through which sound and images are outputted.

The transmission speed of network is continuously increasing. High speed downlink packet access (HSDPA), also known as 3.5G, provides mobile Internet service without area limitation in ordinary conditions, so that portable reception is available in areas where the signals of mobile phones can reach.

However, different systems are required when using the network or the set-top box to receive signals, leading to inconvenient use and high costs.

Thus, a need exists for an integrated type set-top box capable of receiving digital video signals and transmitting the digital video signals to a display through convenient use at low costs.

### BRIEF SUMMARY OF THE INVENTION

The present invention solves this need and other problems in the field of set-top boxes and reception by providing, in a preferred form, an integrated type set-top box including a first receiver receiving a signal transmittable under high speed download packet access. A second receiver receives a signal transmitted from a digital image transmission platform and outputs a demodulated signal. A decoder is coupled to the second receiver. The decoder receives the demodulated signal from the second receiver and decodes the demodulated signal into a decoded signal. A microprocessor is coupled to the first receiver, the decoder, and a display port. The microprocessor receives the signal from the first receiver and the decoded signal from the decoder and selectively outputs the signal from the first receiver or the decoded signal from the decoder to the display port.

In the most preferred form, the microprocessor further includes a computer port adapted to be electrically connected to a computer. The microprocessor selectively outputs the signal from the first receiver or the decoded signal from the decoder to the computer port. The first receiver can be a 3.5G wireless card. The second receiver receives the signal meeting standards of Digital Video Broadcasting-Terrestrial (DVB-T), Advanced Television Systems Committee (ATSC), or Integrated Services Digital Broadcasting-Terrestrial (ISDB-T). A storage medium is coupled to the microprocessor and stores the signal from the first receiver and/or the decoded signal from the decoder.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a diagrammatic block diagram of an integrated type set-top box according to the preferred teachings of the present invention.

The figure is drawn for ease of explanation of the basic teachings of the present invention only; the extensions of the figure with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

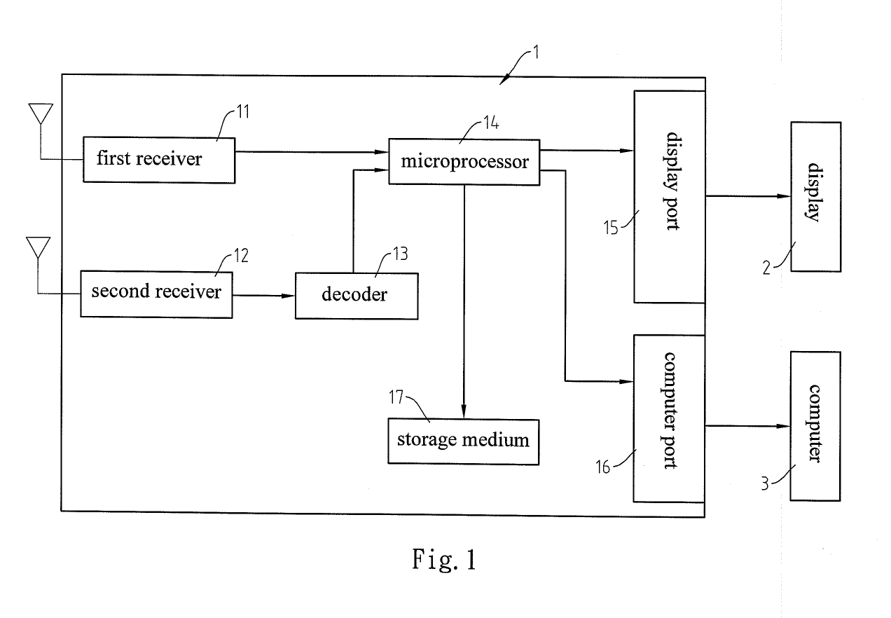

An integrated type set-top box according to the preferred teachings of the present invention is shown in FIG. 1 and generally designated 1. In the preferred form shown, the integrated type set-top box 1 includes a first receiver 11 and a second receiver 12. The second receiver 12 is coupled to a decoder 13. The first receiver 11 and the decoder 13 are coupled to a microprocessor 14, which, in turn, is coupled to a display port 15, a computer port 16, and a storage medium 17 in the most preferred form shown.

The first receiver 11 can be a 3.5G wireless card and capable of receiving signals that are transmittable under high speed download packet access (HSDPA).

The second receiver 12 can receive signals transmitted from a digital image transmission platform and output a demodulated signal. The signals can be signals meeting the standards of Digital Video Broadcasting-Terrestrial (DVB-T), Advanced Television Systems Committee (ATSC), or Integrated Services Digital Broadcasting-Terrestrial (ISDB-T).

The decoder 13 receives the demodulated signal from the second receiver 12 and decodes the demodulate signal into a decoded signal. The microprocessor 14 receives the signal from the first receiver 11 and the decoded signal from the decoder 13. Furthermore, the microprocessor 14 outputs the signal from the first receiver 11 or the decoded signal from the decoder 13 according to needs.

The display port 15 can be electrically connected to a display 2. The computer port 16 can be electrically connected to a computer 3. The storage medium 17 can be a hard disk or a memory card.

When a user is intended to play digital video via the display 2, the display port 15 of the set-top box 1 is coupled to the display 2. The second receiver 12 receives a signal transmitted from a digital image transmission platform and output a demodulated signal to the decoder 13. The decoder 13 decodes the demodulate signal into a decoded signal. The microprocessor 14 sends the decoded signal through the display port 15 to the display 2. Thus, the digital video can be played by using the display 2. It can be appreciated that the microprocessor 14 can transmit the signal from the first receiver 11 or the decoded signal from the decoder 13 to the display 2 under control of the user by using a remote control.

On the other hand, when the user is intended to play the digital video via the computer 3, the computer port 16 of the set-top box 1 is coupled to the computer 3. The microprocessor 14 transmits the signal from the first receiver 11 or the decoded signal from the decoder 13 to the computer 3.

The storage medium 17 can be utilized to store the signal from the first receiver 11 or the decoded signal from the decoder 13, so that the digital video can be recorded when the user has no time to watch the digital video. Alternatively, the decoded signal of the decoder 13 can be stored in the storage medium 17 while the user is watching the digital video transmitted through the first receiver 11.

According to the above, the set-top box I according to the preferred teachings of the present invention can be coupled to a display 2 or a computer 3 and receives signals of different types to provide the user with convenience. Furthermore, the signal from the first receiver 11 or the decoded signal from the decoder 13 can be stored according to needs.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An integrated type set-top box comprising:
a first receiver receiving a signal transmittable under high speed download packet access;
a second receiver for receiving a signal transmitted from a digital image transmission platform and outputting a demodulated signal;
a decoder coupled to the second receiver, with the decoder receiving the demodulated signal from the second receiver and decoding the demodulated signal into a decoded signal;
a display port;
a microprocessor coupled to the first receiver, the decoder, and the display port, with the microprocessor receiving the signal from the first receiver and the decoded signal from the decoder and selectively outputting the signal from the first receiver or the decoded signal from the decoder to the display port.

2. The integrated type set-top box as claimed in claim 1, with the microprocessor further including a computer port adapted to be electrically connected to a computer, and with the microprocessor selectively outputting the signal from the first receiver or the decoded signal from the decoder to the computer port.

3. The integrated type set-top box as claimed in claim 1, with the first receiver being a 3.5G wireless card.

4. The integrated type set-top box as claimed in claim 1, with the second receiver receiving the signal meeting standards of Digital Video Broadcasting-Terrestrial (DVB-T), Advanced Television Systems Committee (ATSC), or Integrated Services Digital Broadcasting-Terrestrial (ISDB-T).

5. The integrated type set-top box as claimed in claim 1, further comprising: a storage medium coupled to the microprocessor, with the storage medium storing the signal from the first receiver and/or the decoded signal from the decoder.

6. The integrated type set-top box as claimed in claim 5, with the storage medium being a hard disk or a memory card.
